(19) United States
(12) Patent Application Publication
(10) Pub. No.: US 2014/0181640 A1
(43) Pub. Date: Jun. 26, 2014

(54) METHOD AND DEVICE FOR STRUCTURING DOCUMENT CONTENTS

(71) Applicants: BEIJING FOUNDER ELECTRONICS CO., LTD., Beijing (CN); PEKING UNIVERSITY FOUNDER GROUP CO., LTD., Beijing (CN)

(72) Inventor: Mingming SUN, Beijing (CN)

(73) Assignees: BEIJING FOUNDER ELECTRONICS CO., LTD., Beijing (CN); PEKING UNIVERSITY FOUNDER GROUP CO., LTD., Beijing (CN)

(21) Appl. No.: 14/096,790

(22) Filed: Dec. 4, 2013

(30) Foreign Application Priority Data
Dec. 20, 2012 (CN) 201210560708.3

(51) Int. Cl. G06F 17/22

(52) U.S. Cl. CPC G06F 17/2247
USPC 715/234

(57) ABSTRACT

A method for structuring document contents includes: generating a first instantiating rule corresponding to a first document based upon a first schema file with a style, which is a preset style, and a first XML file with a rule, which is a first structuring rule, in the first document; obtaining a first list of tags corresponding to structured first contents in the first document based upon a first tag structure tree of the first contents; obtaining M texts matching the first instantiating rule from discrete contents corresponding to the first list of tags, wherein the discrete contents are unstructured contents excluded from the structured first contents; determining N tags which can match the structured first contents among M tags corresponding to the M texts; and structuring N texts corresponding to the N tags based upon the N tags to obtain a second tag structure tree.

The present application claims priority to Chinese Patent Application No. 201210560708.3, filed with the State Intellectual Property Office of China on Dec. 20, 2012 and entitled “Method and device for structuring document contents”, which is hereby incorporated by reference in its entirety.

### FIELD OF THE INVENTION

The present invention relates to the field of printing and particularly to a method and a device for structuring document contents.

### BACKGROUND OF THE INVENTION

A publishing company receiving a large number of contributions needs to make the large number of contributions into books, periodicals and other press works by making a considerable effort to coordinate the contents and structures of the contributions, where for discrete contents in the contributions, for example, answers in a test paper are discrete contents with respect to the test paper while questions are separated from the answers, and details are discrete contents with respect to the entire document of contents while a summary is separated from the details, the contents of these documents need to be coordinated by structuring these discrete answers according to the structure of the questions and structuring the summary according to the structure of the details, and these sections to be structured have both considerable similarities and a certain regularity.

In the prior art, discrete contents in a document have to be structured manually, which is the only alternative to their structuring.

However the applicant have identified at least the following technical problems in the prior art during making the technical solution of the invention in embodiments of the present application:

Since the discrete contents in the document have considerable similarities, and there are significant repeated efforts when the discrete contents are structured manually, technical problems of a low structuring efficiency, a high error ratio and a low structuring ratio may arise.

### SUMMARY OF THE INVENTION

The embodiments of the present application provide a method and a device for structuring document contents so as to address the technical problems in the prior art of a low structuring ratio efficiency and a high error ratio.

In an aspect, an embodiment of the present application provides a method for structuring document contents, the method includes:

generating a first instantiating rule corresponding to a first document based upon a first schema file with a style, which is a preset style, and a first XML file with a rule, which is a first structuring rule, in the first document;

obtaining a first list of tags corresponding to structured first contents in the first document based upon a first tag structure tree of the first contents;

obtaining M texts matching the first instantiating rule from discrete contents corresponding to the first list of tags, wherein the discrete contents are unstructured contents excluded from the structured first contents, and M is a positive integer equal to or larger than 1;

determining N tags which can match the structured first contents among M tags corresponding to the M texts; and

structuring N texts corresponding to the N tags based upon the N tags to obtain a second tag structure tree.

Preferably, generating a first instantiating rule corresponding to a first document based upon a first schema file with a style, which is a preset style, and a first XML file with a rule, which is a first structuring rule, in the first document includes:

achieving the first schema file with a style which is the preset style and the first XML file with a rule which is the first structuring rule;

obtaining the M texts matching the first instantiating rule from the discrete contents corresponding to the first list of tags based upon the first schema file with a style which is the preset style and the first XML file with a rule which is the first structuring rule, and obtaining a plurality of matching nodes corresponding to the M texts from the first contents, wherein the number of matching nodes is larger than M;

obtaining at least one mismatching node corresponding to the M texts from the first contents to generate a second structuring rule; and

composing the first instantiating rule based upon the plurality of matching nodes and the second structuring rule.

Preferably, the first structuring rule includes:

a format matching pattern rule; and/or

a style matching pattern rule; and/or

an outline-level matching pattern rule; and/or

a self-defined wildcard matching pattern rule.

Preferably, obtaining M texts matching the first instantiating rule from discrete contents corresponding to the first list of tags includes:

traversing the first list of tags; and

locating the M texts matching the first instantiating rule in the discrete contents based upon the first list of tags.

Preferably, after locating the M texts matching the first instantiating rule in the discrete contents based upon the first list of tags, the method further includes:

storing the M texts matching the first instantiating rule in a stack; and

setting styles of the M texts matching the first instantiating rule as styles of nodes in the first contents.

Preferably, structuring N texts corresponding to the N tags based upon the N tags includes:

obtaining K texts satisfying a preset regularity among the N texts and structuring the K texts automatically based upon K tags corresponding to the K texts; and

selecting (N−K) parent tags in the first list of tags corresponding to (N−K) texts which do not satisfy the preset regularity in response to an assistant operation of a user when the assistant operation is detected to assist structuring the (N−K) texts.

Preferably, obtaining K texts satisfying a preset regularity among the N texts and structuring the K texts automatically based upon K tags corresponding to the K texts includes:

adding the K tags and K nodes succeeding in matching the K tags to the first list of tags; and

generating K sub-tags corresponding to the K texts in the first list of tags to structure the K texts corresponding to the K tags automatically.

Preferably, after structuring N texts corresponding to the N tags based upon the N tags to obtain a second tag structure tree, the method further includes:

verifying the second tag structure tree for correctness to obtain a verification result; and

presenting the second tag structure tree when the verification result indicates that the second tag structure tree is correct.

In another aspect, an embodiment of the present application provides a device including:

a generating module configured to generate a first instantiating rule corresponding to a first document based upon a first schema file with a style, which is a preset style, and a first XML file with a rule, which is a first structuring rule, in the first document;

a first obtaining module configured to obtain a first list of tags corresponding to structured first contents in the first document based upon a first tag structure tree of the first contents;

a second obtaining module configured to obtain M texts matching the first instantiating rule from discrete contents corresponding to the first list of tags, wherein the discrete contents are unstructured contents excluded from the structured first contents, and M is a positive integer equal to or larger than 1;

a third obtaining module configured to determine N tags which can match the structured first contents among M tags corresponding to the M texts; and

a structuring module configured to structure N texts corresponding to the N tags based upon the N tags to obtain a second tag structure tree.

Preferably, the generating module includes:

an achieving sub-module configured to achieve the first schema file with a style which is the preset style and the first XML file with a rule which is the first structuring rule;

a first obtaining sub-module configured to obtain the M texts matching the first instantiating rule from the discrete contents corresponding to the first list of tags based upon the first schema file with a style which is the preset style and the first XML file with a rule which is the first structuring rule, and to obtain a plurality of matching nodes corresponding to the M texts from the first contents, wherein the number of matching nodes is larger than M;

a second obtaining sub-module configured to obtain at least one mismatching node corresponding to the M texts from the first contents to generate a second structuring rule; and

a composing sub-module configured to compose the first instantiating rule based upon the plurality of matching nodes and the second structuring rule.

Preferably, the second obtaining module includes:

a traversing sub-module configured to traverse the first list of tags; and

a locating sub-module configured to locate the M texts matching the first instantiating rule in the discrete contents based upon the first list of tags.

Preferably, the second obtaining module further includes:

a storing sub-module configured to store the M texts matching the first instantiating rule in a stack; and

a setting sub-module configured to set styles of the M texts matching the first instantiating rule as styles of nodes in the first contents.

Preferably, the structuring module includes:

an automatic structuring sub-module configured to obtain K texts satisfying a preset regularity among the N texts and to structure the K texts automatically based upon K tags corresponding to the K texts; and

a secondary structuring sub-module configured to select (N−K) parent tags in the first list of tags corresponding to (N−K) texts which do not satisfy the preset regularity in response to an assistant operation of a user when the assistant operation is detected to assist structuring the (N−K) texts.

Preferably, the automatic structuring sub-module includes:

an adding unit configured to add the K tags and K nodes succeeding in matching the K tags to the first list of tags; and

a generating unit configured to generate K sub-tags corresponding to the K texts in the first list of tags to structure the K texts corresponding to the K tags automatically.

Preferably, the device further includes:

a verifying module configured to verify the second tag structure tree for correctness to obtain a verification result; and

a presenting module configured to present the second tag structure tree when the verification result indicates that the second tag structure tree is correct.

One or more technical solutions according to the embodiments of the present application at least have the following technical effects or advantages.

1. With the technical means by which a text matching an instantiating rule is obtained in discrete contents and the text is structured based upon a tag of the text, the technical problems in the prior art of a low efficiency and a high error ratio in structuring the discrete contents can be addressed effectively, and further achieving a technical effect of rapid structuring of the discrete contents without changing the structure of the contents of the document, thereby improving the efficiency and the error ratio in structuring the discrete contents.

2. With the technical means by which a first instantiating rule corresponding to a first document is generated based upon a first schema file with a style, which is a preset style, and a first XML file with a rule, which is a first structuring rule, in the first document, the generated first instantiating rule can match a text which would otherwise can not match a structuring rule determined by a developer, thereby effectively addressing the technical problem in the prior art of a low structuring efficiency of discrete contents and further achieving a technical effect of an improved matching ratio of the discrete contents.

### BRIEF DESCRIPTION OF THE DRAWINGS

FIG. 1 is a flow chart of a method for structuring document contents in an embodiment of the invention;

FIG. 2 is a detailed flow chart of the step S101 in the method for structuring document contents in the embodiment of the invention;

FIG. 3 is a detailed flow chart of the step S103 in the method for structuring document contents in the embodiment of the invention;

FIG. 4 is a block diagram of a method for structuring contents of a test paper in an embodiment of the invention;

FIG. 5 is a flow chart of a preferred implementation of the method for structuring contents of a test paper in the embodiment of the invention; and

FIG. 6 is a modular diagram of a device in an embodiment of the invention.

### DETAILED DESCRIPTION OF THE EMBODIMENTS

Embodiments of the present application provide a method and device for structuring document contents so as to address the technical problems in the prior art of a low structuring ratio efficiency and a high error ratio.

A technical solution in an embodiment of the invention is intended to address the problems in the prior art of a low structuring efficiency and a high error ratio in structuring discrete contents based upon the following general idea.

A first instantiating rule corresponding to a first document is generated based upon a first schema file with a style, which is a preset style, and a first XML file with a rule, which is a first structuring rule, in the first document; a first list of tags corresponding to structured first contents in the first document is obtained based upon a first tag structure tree of the first contents; M texts matching the first instantiating rule are obtained from discrete contents corresponding to the first list of tags, where the discrete contents are unstructured contents excluded from the structured first contents, and M is a positive integer equal to or larger than 1; N tags which can match the structured first contents are determined among M tags corresponding to the M texts; and N texts corresponding to the N tags are structured based upon the N tags to obtain a second tag structure tree.

A text matching with an instantiating rule is obtained from the discrete contents to thereby alleviate the problem of an error in a manual search for a text to be structured, and then a tag corresponding to the text matching with the instantiating rule is obtained and the text to be structured is structured, so this non-manual structuring method can improve the efficiency of structuring and lower an error ratio of structuring.

In order to better understanding the foregoing technical solution, the technical solution will be described below in details with reference to the drawings and particular embodiments thereof.

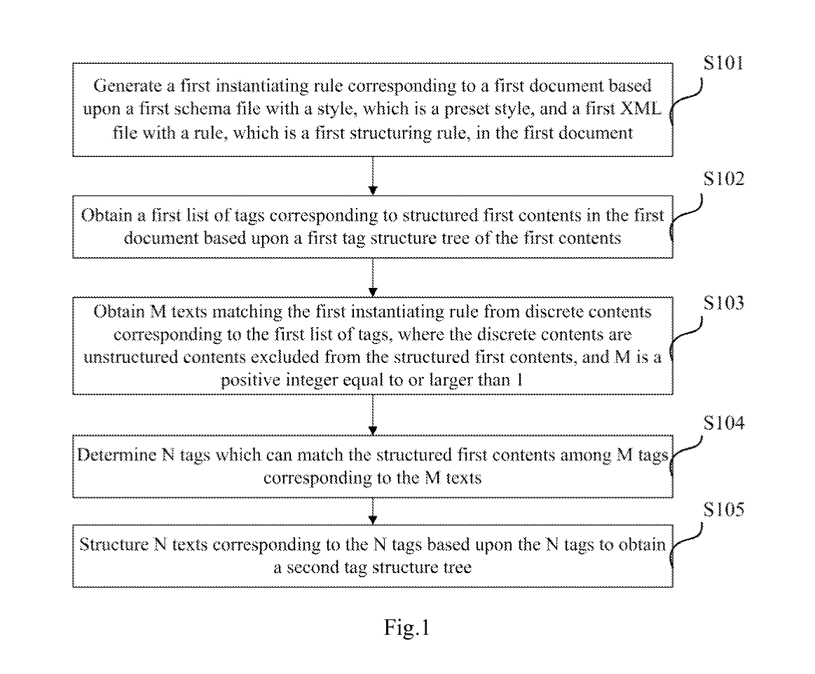

An embodiment of the present application provides a method for structuring document contents, and referring to FIG. 1, the method includes the following steps.

Step S101: A first instantiating rule corresponding to a first document is generated based upon a first schema file with a style, which is a preset style, and a first XML file with a rule, which is a first structuring rule, in the first document.

In a particular implementation, the first document is a schema instant document, and the first schema file and XML file are embedded in the first document, where the XML file is typically a file developed by a developer, and in a particular implementation, a structuring rule corresponding to the XML file developed by the developer can be adopted directly, or a new instantiating rule can be generated.

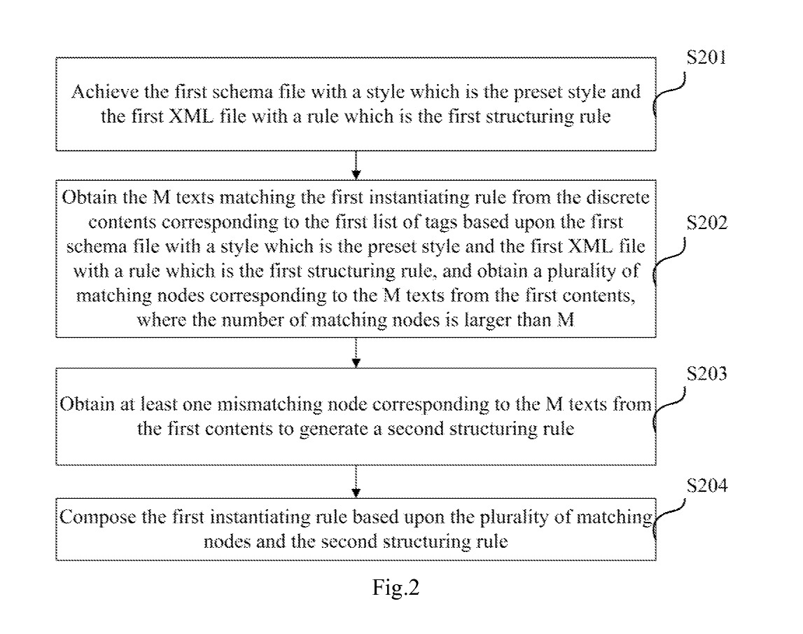

In a particular embodiment, a new instantiating rule will be generated for a higher ratio of discrete contents matching with nodes in first contents, and reference can be made to FIG. 2 for particular steps thereof, where FIG. 2 is a detailed flow chart of the step S101 in the method for structuring document contents in the embodiment of the invention.

S201: The first schema file with a style which is the preset style and the first XML file with a rule which is the structuring rule are achieved.

S202: The M texts matching the first instantiating rule are obtained from the discrete contents corresponding to the first list of tags based upon the first schema file with a style which is the preset style and the first XML file with a rule which is the first structuring rule, and a plurality of matching nodes corresponding to the M texts are obtained from the first contents, where the number of matching nodes is larger than M.

Particularly, the first structuring rule is a format matching pattern rule and/or a style matching pattern rule and/or an outline-level matching pattern rule and/or a self-defined wildcard matching pattern rule.

S203: At least one mismatching node corresponding to the M texts is obtained from the first contents to generate a second structuring rule.

Particularly, the second structuring rule can also be one or more of a format matching pattern rule, a style matching pattern rule, an outline-level matching pattern rule and a self-defined wildcard matching pattern rule.

S204: The first instantiating rule is composed based upon the plurality of matching nodes and the second structuring rule.

Particularly, in this particular embodiment, the second structuring rule is set for nodes, in the first contents, failing to match the M texts, based upon the structuring rule of the XML file in the document, and the first instantiating rule is generated based upon nodes succeeding in matching and the second structuring rule, thereby improving a ratio of the discrete contents matching with the nodes in the first contents, for example, the structuring rule of the XML file is a style matching pattern based upon which only a small number of matching nodes can be obtained, and then a structuring rule can be generated based upon the nodes failing to match, for example, a matching pattern of the nodes failing to match is a wildcard matching pattern which can be set as the second structuring rule, so the two matching patters which are the wildcard matching pattern and the style matching pattern can be combined into the first instantiating rule.

In a particular implementation, the formed first instantiating rule can be further refined into a structuring rule catering to a user demand.

The step S102 is performed, where a first list of tags corresponding to structured first contents in the first document is obtained based upon a first tag structure tree of the first contents.

In a particular implementation, the steps S101 and S102 may not be performed in a strict order, so the present application will not be limited in terms of the order in which the steps S101 and S102 are performed.

Particularly, the present application will not be limited in terms of the contents of the first document, for example, the first document can be a document of a test paper, and then the first contents are the structured section of questions, and the discrete contents are the section of answers.

After the step S102 or S101 is performed, the step S103 is performed, where M texts matching the first instantiating rule are obtained from discrete contents corresponding to the first list of tags, where the discrete contents are unstructured contents excluded from the structured first contents, and M is a positive integer equal to or larger than 1.

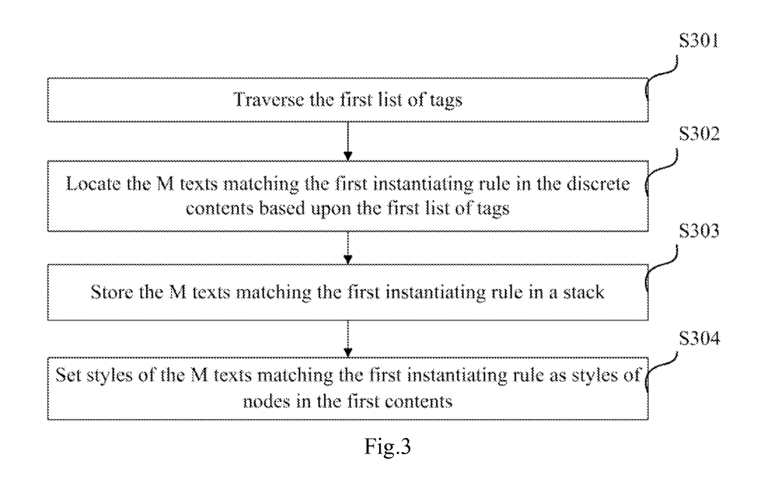

In a particular embodiment, reference can be made to FIG. 3 for a method for obtaining the M texts matching the first instantiating rule from the discrete contents, where FIG. 3 is a detailed flow chart of the step S103 in the method for structuring document contents in the embodiment of the invention, including the following steps.

S301: The first list of tags is traversed.

S302: The M texts matching the first instantiating rule are located in the discrete contents based upon the first list of tags.

S303: The M texts matching the first instantiating rule are stored in a stack.

S304: Styles of the M texts matching the first instantiating rule are set as styles of nodes in the first contents.

Particularly, the first list of tags is traversed by locating a text, in the discrete contents, corresponding to each tag throughout the list of tags of the first document.

Then the located texts are stored sequentially in the stack, and the text corresponding to the tag is set as the style of the node succeeding in matching the text.

After the step S103 is performed, the step S104 is performed, where N tags which can match the structured first contents are determined among M tags corresponding to the M texts.

In a particular embodiment, the step S104 can be performed particularly by the following particular steps.

Step 1: K texts satisfying a preset regularity among the N texts are obtained, and the K texts are structured automatically based upon K tags corresponding to the K texts.

Particularly, firstly the K tags and K nodes succeeding in matching the K tags are added to the first list of tags; and then K sub-tags corresponding to the K texts are generated in the first list of tags to structure the K texts corresponding to the K tags automatically.

Step 2: After that, (N−K) parent tags in the first list of tags corresponding to (N−K) texts which do not satisfy the preset regularity are selected in response to an assistant operation of the user when the assistant operation is detected to assist structuring the (N−K) texts.

In a particular implementation, a preferred implementation includes: firstly, the step 1 is performed to structure the discrete contents automatically, and after automatic structuring, then the step 2 is performed to assist structuring the (N−K) texts failing to be structured automatically to improve the rate of structuring. Certainly in a particular implementation, the step 1 and the step 2 can be performed concurrently, so the present application will not be limited to the preferred implementation.

After the step S104 is performed, the step S105 is performed, where N texts corresponding to the N tags are structured based upon the N tags to obtain a second tag structure tree.

In a particular implementation, after the N texts corresponding to the N tags are structured based upon the N tags to obtain the second tag structure tree, the generated second tag structure tree can be verified for an effect of structuring the discrete contents. Particular steps are as follows.

The second tag structure tree is verified for correctness to obtain a verification result.

The second tag structure tree is presented when the verification result indicates that the second tag structure tree is correct.

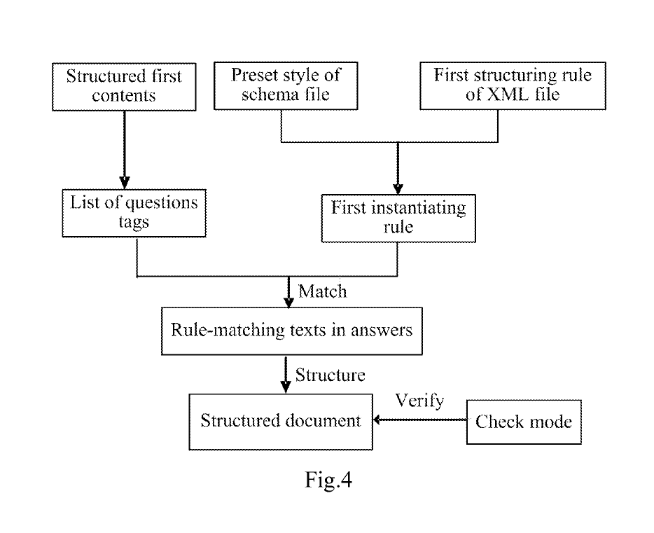

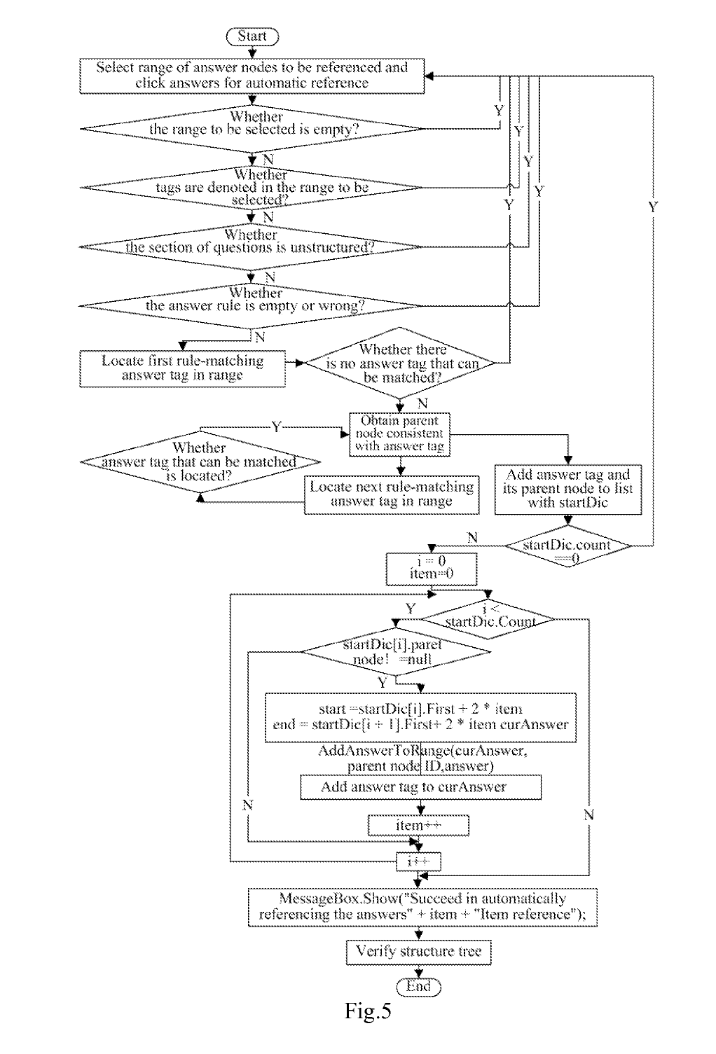

A preferred method for structuring discrete contents will be further described below in details with reference to FIG. 4 and FIG. 5 by taking a method for structuring a section of answers in a paper test as an example, where a section of questions is a structured consecutive section. Firstly, referring to FIG. 4, an instantiating rule for structuring the section of answers in the paper test is generated based upon a schema file and an XML file embedded in the paper test. Then a list of tags of the section of questions is obtained based upon a tag structure tree of the section of questions, and then texts matching the instantiating rule among the answers are obtained.

Reference can be made to FIG. 5 for a particular matching implementation process, and the matching process will be described in details below with reference to FIG. 5.

Firstly, a range is selected in which nodes of answers need to be referenced, that is, a range of questions, and references to the answers are selected in correspondence to the range of questions, where the following four points are taken into account for matching.

Firstly, it is determined that whether the range of questions exists.

Secondly, it is determined that whether there is any tag denoted in the section of questions in the range, that is, whether the section of answers corresponding to the section of questions has been structured.

Thirdly, it is determined that whether the section of questions in the range has been structured.

Fourthly, it is determined that whether a rule of the answers is correct.

After that, when all of the four points above are satisfied, answer tags that can be matched among the answers are obtained sequentially, and then the answer tags and corresponding parent nodes are added to the list of tags corresponding to the section of questions.

Next answer sub-tags are added sequentially to the generated tags to structure the answers.

Finally, after structuring, a structure tree of the structured section of answers is verified in a check mode.

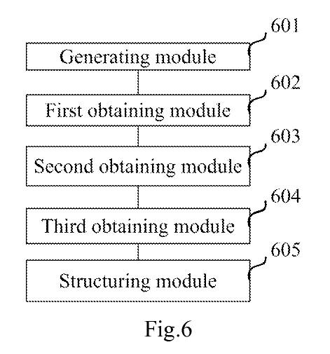

Based upon the same inventive idea, an embodiment of the present invention provides a device configured to perform the method for structuring document contents in the foregoing embodiment, and reference can be made to FIG. 6 for modules of the device which particularly includes the following modules.

A generating module 601 is configured to generate a first instantiating rule corresponding to a first document based upon a first schema file with a style, which is a preset style, and a first XML file with a rule, which is a first structuring rule, in the first document.

A first obtaining module 602 is configured to obtain a first list of tags corresponding to structured first contents in the first document based upon a first tag structure tree of the first contents.

A second obtaining module 603 is configured to obtain M texts matching the first instantiating rule from discrete contents corresponding to the first list of tags, where the discrete contents are unstructured contents excluded from the structured first contents, and M is a positive integer equal to or larger than 1.

A third obtaining module 604 is configured to determine N tags which can match the structured first contents among M tags corresponding to the M texts.

A structuring module 605 is configured to structure N texts corresponding to the N tags based upon the N tags to obtain a second tag structure tree.

Furthermore in a particular embodiment, the generating module particularly includes:

An achieving sub-module configured to achieve the first schema file with a style which is the preset style and the first XML file with a rule which is the first structuring rule;

A first obtaining sub-module configured to obtain the M texts matching the first instantiating rule from the discrete contents corresponding to the first list of tags based upon the first schema file with a style which is the preset style and the first XML file with a rule which is the first structuring rule, and to obtain a plurality of matching nodes corresponding to the M texts from the first contents, where the number of matching nodes is larger than M;

A second obtaining sub-module configured to obtain at least one mismatching node corresponding to the M texts from the first contents to generate a second structuring rule; and

A composing sub-module configured to compose the first instantiating rule based upon the plurality of matching nodes and the second structuring rule.

Furthermore, in a particular embodiment, the second obtaining module particularly includes:

A traversing sub-module configured to traverse the first list of tags; and

A locating sub-module configured to locate the M texts matching the first instantiating rule in the discrete contents based upon the first list of tags.

Furthermore, in a particular embodiment, the second obtaining module further includes:

A storing sub-module configured to store the M texts matching the first instantiating rule in a stack; and

A setting sub-module configured to set styles of the M texts matching the first instantiating rule as styles of nodes in the first contents.

Furthermore, in a particular embodiment, the structuring module particularly includes:

An automatic structuring sub-module configured to obtain K texts satisfying a preset regularity among the N texts and to structure the K texts automatically based upon K tags corresponding to the K texts; and

A secondary structuring sub-module configured to select (N−K) parent tags in the first list of tags corresponding to (N−K) texts which do not satisfy the preset regularity in response to an assistant operation of a user when the assistant operation is detected to assist structuring the (N−K) texts.

Furthermore in a particular embodiment, the automatic structuring sub-module particularly includes:

An adding unit configured to add the K tags and K nodes succeeding in matching the K tags to the first list of tags; and

A generating unit configured to generate K sub-tags corresponding to the K texts in the first list of tags to structure the K texts corresponding to the K tags automatically.

Furthermore in a particular embodiment, the device further includes:

A verifying module configured to verify the second tag structure tree for correctness to obtain a verification result; and

A presenting module configured to present the second tag structure tree when the verification result indicates that the second tag structure tree is correct.

One or more technical solutions in the embodiments of the invention have at least the following technical effects or advantages.

1. With the technical means by which a text matching an instantiating rule is obtained in discrete contents and the text is structured based upon a tag of the text, the technical problems in the prior art of a low efficiency and a high error ratio in structuring the discrete contents can be addressed effectively, and further achieving a technical effect of rapid structuring of the discrete contents without changing the structure of the contents of the document, thereby improving the efficiency and the error ratio in structuring the discrete contents.

2. With the technical means by which a first instantiating rule corresponding to a first document is generated based upon a first schema file with a style, which is a preset style, and a first XML file with a rule, which is a first structuring rule, in the first document, the generated first instantiating rule can match a text which would otherwise can not match a structuring rule determined by a developer, thereby effectively addressing the technical problem in the prior art of a low structuring efficiency of discrete contents and further achieving a technical effect of an improved matching ratio of the discrete contents.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method for structuring document contents, comprising:
generating a first instantiating rule corresponding to a first document based upon a first schema file with a style, which is a preset style, and a first XML file with a rule, which is a first structuring rule, in the first document;
obtaining a first list of tags corresponding to structured first contents in the first document based upon a first tag structure tree of the first contents;
obtaining M texts matching the first instantiating rule from discrete contents corresponding to the first list of tags, wherein the discrete contents are unstructured contents excluded from the structured first contents, and M is a positive integer equal to or larger than 1;
determining N tags which can match the structured first contents among M tags corresponding to the M texts; and
structuring N texts corresponding to the N tags based upon the N tags to obtain a second tag structure tree.

2. The method according to claim 1, wherein generating a first instantiating rule corresponding to a first document based upon a first schema file with a style, which is a preset style, and a first XML file with a rule, which is a first structuring rule, in the first document comprises:
achieving the first schema file with a style which is the preset style and the first XML file with a rule which is the first structuring rule;
obtaining the M texts matching the first instantiating rule from the discrete contents corresponding to the first list of tags based upon the first schema file with a style which is the preset style and the first XML file with a rule which is the first structuring rule, and obtaining a plurality of matching nodes corresponding to the M texts from the first contents, wherein the number of matching nodes is larger than M;
obtaining at least one mismatching node corresponding to the M texts from the first contents to generate a second structuring rule; and
composing the first instantiating rule based upon the plurality of matching nodes and the second structuring rule.

3. The method according to claim 2, wherein the first structuring rule comprises:
a format matching pattern rule; and/or
a style matching pattern rule; and/or
an outline-level matching pattern rule; and/or
a self-defined wildcard matching pattern rule.

4. The method according to claim 1, wherein obtaining M texts matching the first instantiating rule from discrete contents corresponding to the first list of tags comprises:
traversing the first list of tags; and
locating the M texts matching the first instantiating rule in the discrete contents based upon the first list of tags.

5. The method according to claim 4, wherein after locating the M texts matching the first instantiating rule in the discrete contents based upon the first list of tags, the method further comprises:
storing the M texts matching the first instantiating rule in a stack; and
setting styles of the M texts matching the first instantiating rule as styles of nodes in the first contents.

6. The method according to claim 1, wherein structuring N texts corresponding to the N tags based upon the N tags comprises:
obtaining K texts satisfying a preset regularity among the N texts and structuring the K texts automatically based upon K tags corresponding to the K texts; and
selecting (N−K) parent tags in the first list of tags corresponding to (N−K) texts which do not satisfy the preset regularity in response to an assistant operation of a user when the assistant operation is detected to assist structuring the (N−K) texts.

7. The method according to claim 4, wherein obtaining K texts satisfying a preset regularity among the N texts and structuring the K texts automatically based upon K tags corresponding to the K texts comprises:
adding the K tags and K nodes succeeding in matching the K tags to the first list of tags; and
generating K sub-tags corresponding to the K texts in the first list of tags to structure the K texts corresponding to the K tags automatically.

8. The method according to claim 1, wherein after structuring N texts corresponding to the N tags based upon the N tags to obtain a second tag structure tree, the method further comprises:
verifying the second tag structure tree for correctness to obtain a verification result; and
presenting the second tag structure tree when the verification result indicates that the second tag structure tree is correct.

9. A device, comprising:
a generating module configured to generate a first instantiating rule corresponding to a first document based upon a first schema file with a style, which is a preset style, and a first XML file with a rule, which is a first structuring rule, in the first document;
a first obtaining module configured to obtain a first list of tags corresponding to structured first contents in the first document based upon a first tag structure tree of the first contents;
a second obtaining module configured to obtain M texts matching the first instantiating rule from discrete contents corresponding to the first list of tags, wherein the discrete contents are unstructured contents excluded from the structured first contents, and M is a positive integer equal to or larger than 1;
a third obtaining module configured to determine N tags which can match the structured first contents among M tags corresponding to the M texts; and
a structuring module configured to structure N texts corresponding to the N tags based upon the N tags to obtain a second tag structure tree.

10. The device according to claim 9, wherein the generating module comprises:
an achieving sub-module configured to achieve the first schema file with a style which is the preset style and the first XML file with a rule which is the first structuring rule;
a first obtaining sub-module configured to obtain the M texts matching the first instantiating rule from the discrete contents corresponding to the first list of tags based upon the first schema file with a style which is the preset style and the first XML file with a rule which is the first structuring rule, and to obtain a plurality of matching nodes corresponding to the M texts from the first contents, wherein the number of matching nodes is larger than M;
a second obtaining sub-module configured to obtain at least one mismatching node corresponding to the M texts from the first contents to generate a second structuring rule; and
a composing sub module configured to compose the first instantiating rule based upon the plurality of matching nodes and the second structuring rule.

11. The device according to claim 9, wherein the second obtaining module comprises:
a traversing sub-module configured to traverse the first list of tags; and
a locating sub-module configured to locate the M texts matching the first instantiating rule in the discrete contents based upon the first list of tags.

12. The device according to claim 11, wherein the second obtaining module further comprises:
a storing sub-module configured to store the M texts matching the first instantiating rule in a stack; and
a setting sub-module configured to set styles of the M texts matching the first instantiating rule as styles of nodes in the first contents.

13. The device according to claim 9, wherein the structuring module comprises:
an automatic structuring sub-module configured to obtain K texts satisfying a preset regularity among the N texts and to structure the K texts automatically based upon K tags corresponding to the K texts; and
a secondary structuring sub-module configured to select (N−K) parent tags in the first list of tags corresponding to (N−K) texts which do not satisfy the preset regularity in response to an assistant operation of a user when the assistant operation is detected to assist structuring the (N−K) texts.

14. The device according to claim 13, wherein the automatic structuring sub-module comprises:
an adding unit configured to add the K tags and K nodes succeeding in matching the K tags to the first list of tags; and
a generating unit configured to generate K sub-tags corresponding to the K texts in the first list of tags to structure the K texts corresponding to the K tags automatically.

15. The device according to claim 9, further comprising:
a verifying module configured to verify the second tag structure tree for correctness to obtain a verification result; and
a presenting module configured to present the second tag structure tree when the verification result indicates that the second tag structure tree is correct.
